(19) United States
(12) Patent Application Publication
(10) Pub. No.: US 2008/0314489 A1
(43) Pub. Date: Dec. 25, 2008

(54) Large-Sized Foam Inner Tube for a Tire

(75) Inventor: Jose Merino Lopez, Riom (FR)

Correspondence Address: BUCHANAN, INGERSOLL & ROONEY PC, POST OFFICE BOX 1404, ALEXANDRIA, VA, 22313-1404, US

(73) Assignee: MICHELIN RECHERCHE ET TECHNIQUE S.A., Granges-Paccot (CH)

(21) Appl. No.: 12/158,127

(22) PCT Filed: Dec. 20, 2006
(86) PCT No.: PCT/EP2006/070043

§ 371 Date: Jun. 19, 2008

(30) Foreign Application Priority Data
Dec. 23, 2005 (FR) 0513386

(51) Int. Cl. B60C 5/00

(52) U.S. Cl. 152/450

(57) ABSTRACT

Inner tube for an inflatable assembly consisting of a tire and of a rim, the said chamber consisting of material of the foam type, characterized in that the said chamber has a length Lc of the normal section of the inner tube greater than the length Lpi of the internal cross section of the corresponding tire mounted on its rim and that in contact with the internal air. This then yields the relationship Lc>Lpi and, in an alternative form, Lc=Lpi.

### BACKGROUND OF THE INVENTION

There are many noises that contaminate the surroundings of a vehicle. Some of these are due to the tires. Included in this category, one part of the spectrum that is particularly troublesome is the cavity mode. The cavity mode corresponds to the resonance of the column of air inside the tire. One first aspect of the invention is to contribute to improving comfort in the vehicle by minimizing the road noise that stems from the tire.

In another aspect, the invention aims to contribute to extended mobility by affording an effective means of keeping the tire inflated even if the tire is punctured by a foreign body.

The range of frequencies of noise inside the vehicle and which are associated with the rolling tire is from 80 to 500 Hz. The frequency of the cavity mode is dependent on the size of the tire. At very low speed, the peak of the first cavity mode (FCM) is around 230 Hz.

When the tire is rolling, two peaks occur. At 80 km/h the frequencies of these peaks are 210 and 250 Hz approximately. FIG. 1 clearly shows these frequencies. From a subjective comfort viewpoint, the peaks of the FCM are troublesome because they are very audible.

It is known that arranging moving elements inside the tire can have a positive effect on the interior noise, particularly by damping the first cavity mode. Document EP 1214205 B1 illustrates this principle well. Particles of open-cell materials are arranged inside the cavity of the tire.

Other methods involve “bristles” inside the cavity, for example as disclosed in document U.S. Pat. No. 6,343,843.

Moreover, filling the cavity with a foam or some other material, such as sand, is disclosed in document US 2001/0004924.

U.S. Pat. No. 4,252,378 describes an arrangement whereby the rim is filled with a foam.

EP1510366 A1 describes an arrangement with a noise-damping body positioned under the crown region.

The above systems are complicated and expensive.

### SUMMARY OF THE INVENTION

To alleviate these disadvantages the invention proposes an inflatable assembly consisting of an inner tube, of a tire and of a rim, all of suitable dimensions, the said chamber consisting of material of the foam type, wherein the said chamber has a length Lc of the normal section of the inner tube greater than the length Lpi of the internal cross section of the corresponding tire mounted on its rim.

This then yields the relationship Lc>Lpi and, in an alternative form, Lc≧Lpi.

The noise reduction is highly significant. The impact is greater than 4 dBA in the regions of the spectrum that correspond to the peaks of the first cavity mode (FCM) and at frequencies of between 300 and 350 Hz.

The effect on noise is all the more positive if the chamber is large with respect to the tire, which means that, even after inflation, the surface of the chamber is not taut and is folded. These folds play a positive part in absorbing the noise and mean that the geometry of the cavity is less “uniform”.

The chamber may have a relatively small size with respect to the tire and be tensioned upon inflation, as is customary in the case of inner tubes.

According to one embodiment of the invention, Lc and Lpi are dimensioned such that: 2.5 Lpi≧Lc≧Lpi. This is a range in which the effectiveness is great, with advantageous mechanical characteristics.

According to another embodiment of the invention, Lc and Lpi are dimensioned such that: Lc>2.5 Lpi. This is a range in which the noise reduction principle is highly effective, although such chambers are heavier and more difficult to fit in the inflated assembly.

The thickness of the foam chamber advantageously lies between 0.5 and 10 mm. The interval of between 1 and 4 mm is the preferred interval.

There are advantageously two main types of chamber that are oversized with respect to the corresponding tire. Firstly, smooth foam chambers. The foam expands, increasing the dimensions of the chamber. Second, crumpled foam chambers. The foam expands partially towards the inside of the chamber, folding it. The end appearance of this embodiment resembles the convolutions of the brain.

### BRIEF DESCRIPTION OF THE DRAWINGS

All the embodiment details are given in the description which follows, supplemented by FIGS. 1 to 8 appended hereto, in which:

FIG. 1 illustrates the typical spectrum of a vehicle driving at 80 km/h;

FIG. 2 illustrates an example of an assembly with a chamber according to the invention, shown without pressure;

FIG. 3 graphically illustrates the improvement obtained with a chamber according to the invention;

FIG. 4 illustrates an example of an assembly with a chamber according to the invention shown with pressure;

FIGS. 5 and 7 illustrate various examples of materials from which to make the chamber, and certain types of possible arrangement;

FIG. 6 illustrates an example of an assembly with the chamber according to the invention shown with pressure, the tire being punctured, but not the chamber, thanks to the characteristics of the invention;

FIG. 8 shows a particular embodiment in which the chamber is crumpled.

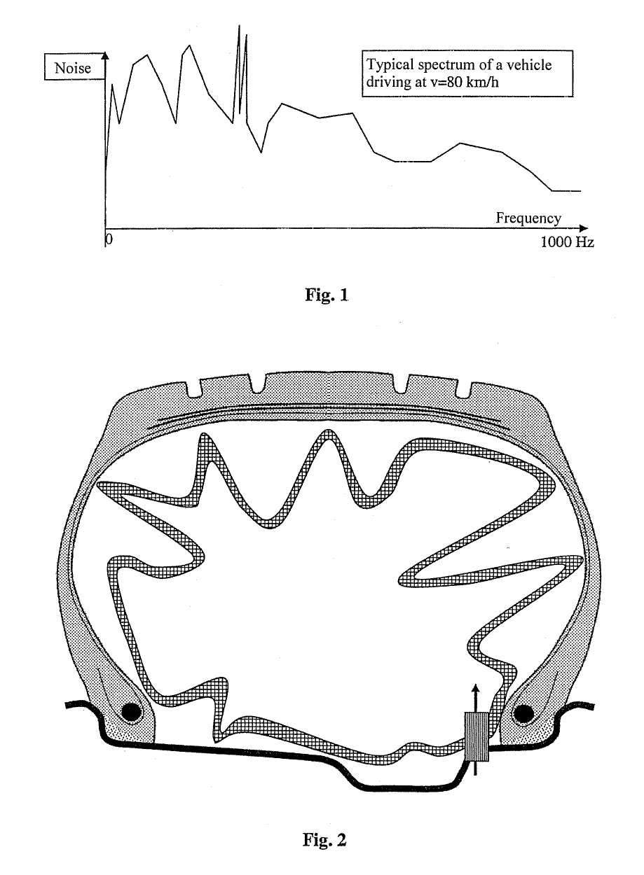

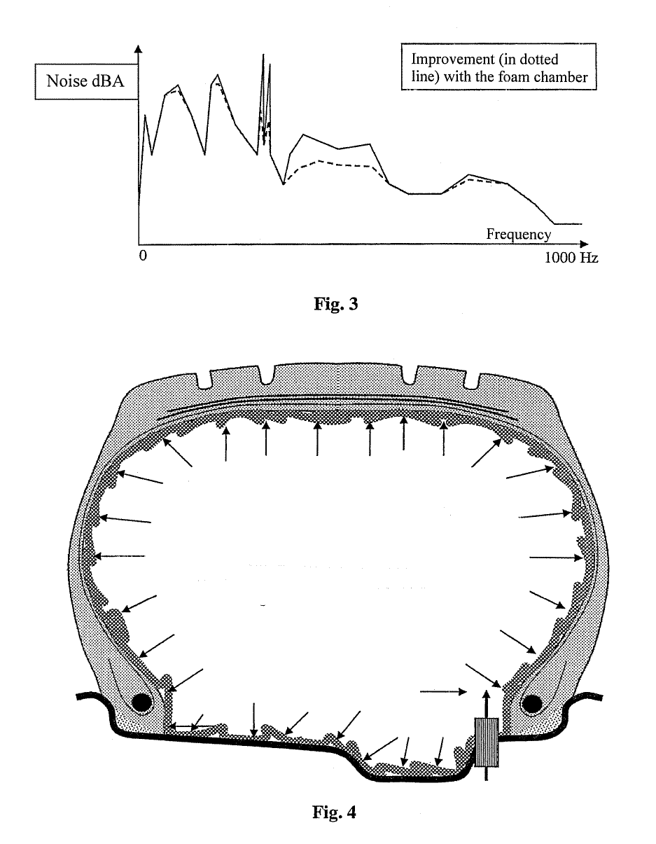

### DETAILED DESCRIPTION OF THE INVENTION

The proposed solution is based on producing a foam inner tube. The inner tube is in contact with the internal air and is able to absorb variations in pressure. This chamber isolates the internal air from the tire itself and from the rim. As a preference, contact between the chamber and the tire is not perfectly adherent.

Tests have also demonstrated that it is possible to obtain advantageous results for lengths Lc<Lpi, particularly Lpi>Lc>0.75 Lpi.

The density of the foam may range from 0.04 g/cm³ to 0.6 g/cm³. The optimum between absorption quality and mass of the mounted assembly is between 0.06 and 0.3 g/cm³.

Closed-cell foams are advantageous in this application (foams preferably containing butyl). However, open-cell foams are advantageously used.

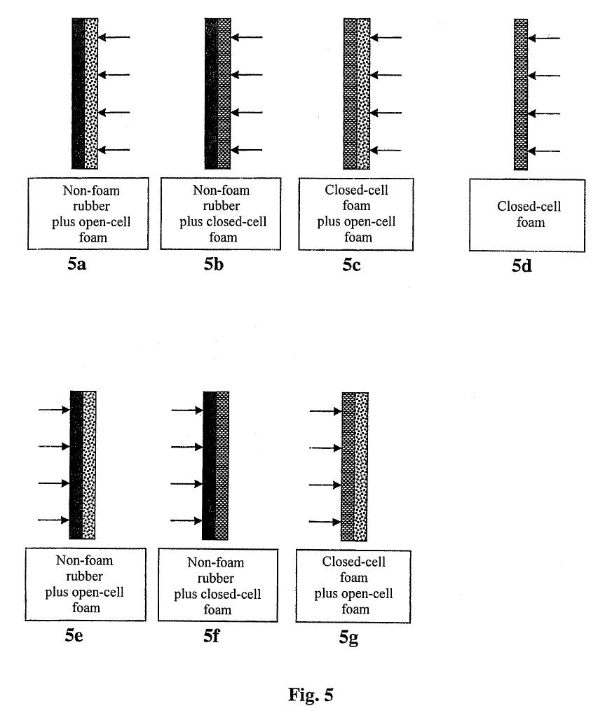

One preferred embodiment is to use an open-cell foam in contact with the pressurized air and a closed-cell foam in contact with the tire and the rim. FIGS. 5a to 5g show examples of possible arrangements.

This inner tube may play a part in making the tire airtight. When an open-cell foam is used, it is necessary for airtightness to incorporate a layer having low permeability to air (a non-foam rubber, preferably butyl or alternatively a closed-cell foam preferably made of butyl).

The chamber with overlength at the same time is able to offer greater robustness to punctures, allowing the airtight sealing layer to deform to fit around the perforating element. For the robustness of this application it is advantageous for the foam chamber to be reinforced with a protective fabric. We can conceive of all the combinations of the above solutions with the protective fabric. Refer to the examples of FIGS. 7a to 7d, in which the fabric is shown in the white or unpatterned region of the drawings.

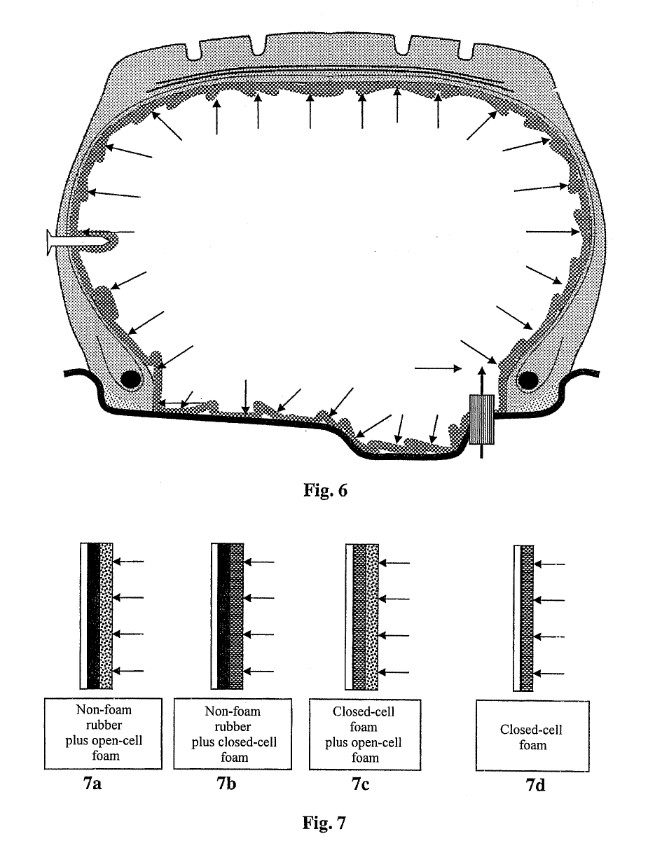

There are two main types of chamber that are oversized with respect to the corresponding tire. First, as illustrated in FIGS. 2, 4 and 6, smooth foam chambers. The foam expands, increasing the dimensions of the chamber.

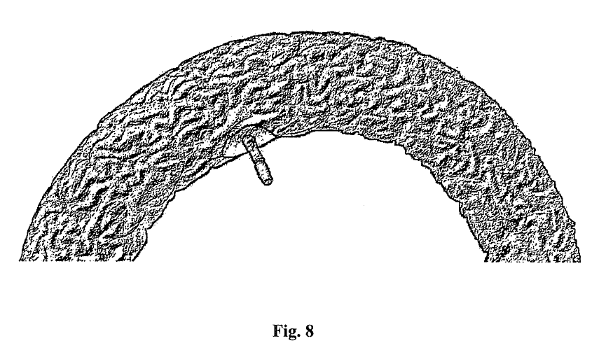

Second, as illustrated in FIG. 8, crumpled foam chambers. The foam expands partially towards the inside of the chamber, folding it. The end appearance of this embodiment resembles the convolutions of the brain.

One of the major advantages of these embodiments lies in the fact that the chambers can be manufactured, on the one hand, in a standard mould, and, on the other hand, using a standard method. The cost of this chamber is therefore substantially the same as that of the standard chamber.

1. An inflatable assembly consisting of an inner tube, of a tire and of a rim, all of suitable dimensions, the said chamber consisting of material of the foam type, wherein the said chamber has a length Lc of the normal section of the inner tube greater than the length Lpi of the internal cross section of the corresponding tire mounted on its rim.

2. The inflatable assembly of claim 1, wherein 2.5 Lpi≧Lc≧Lpi.

3. The inflatable assembly of claim 1, wherein Lc>2.5 Lpi.

4. An inner tube for an the inflatable assembly according to, claim 1 wherein the thickness of the foam chamber lies between 0.5 and 10 mm.

5. An inner tube for an the inflatable assembly according to claim 1 wherein the foam chamber is smooth.

6. An inner tube for the inflatable assembly according to claim 1 wherein the foam chamber is crumpled.
